(19) United States
(12) Patent Application Publication
(10) Pub. No.: US 2026/0145642 A1
(43) Pub. Date: May 28, 2026

(54) VEHICULAR VISION SYSTEM WITH IDENTIFICATION OF AUTHORIZED USER

(71) Applicant: Magna Electronics Inc., Auburn Hills, MI (US)

(72) Inventors: Jeremy J. Baca, Ann Arbor, MI (US); Naresh Ravuri, Novi, MI (US)

(21) Appl. No.: 19/382,500

(22) Filed: Nov. 7, 2025

Related U.S. Application Data
(60) Provisional application No. 63/723,625, filed on Nov. 22, 2024.

(51) Int. Cl. B60R 25/25; B60R 25/01; B60R 25/24; B60R 25/30; B60R 25/31

(52) U.S. Cl. CPC B60R 25/25; B60R 25/01; B60R 25/24; B60R 25/305; B60R 25/31

(57) ABSTRACT

A vehicular sensing system includes an exterior-viewing camera disposed at a vehicle and viewing a region adjacent to a door of the vehicle. The system is operable to detect presence of a person exterior of the vehicle via processing image data captured by the camera. Based on not detecting the presence of a person, the system operates in a first state where image data captured by the camera is processed at a first resolution, and based on detecting the presence of a person, the system operates in a second state where image data captured by the camera is processed at a greater second resolution. Responsive to detecting the presence of a person, the system determines whether the detected person is an authorized user of the vehicle and allows an authorized user to access the vehicle.

### CROSS REFERENCE TO RELATED APPLICATION

The present application claims the filing benefits of U.S. provisional application Ser. No. 63/723,625, filed Nov. 22, 2024, which is hereby incorporated herein by reference in its entirety.

### FIELD OF THE INVENTION

The present invention relates generally to a vehicle vision system for a vehicle and, more particularly, to a vehicle vision system that utilizes one or more exterior sensors at a vehicle.

### BACKGROUND OF THE INVENTION

Use of imaging sensors in vehicle imaging systems is common and known. Examples of such known systems are described in U.S. Pat. Nos. 10,819,943; 5,949,331; 5,670,935 and/or 5,550,677, which are hereby incorporated herein by reference in their entireties.

### SUMMARY OF THE INVENTION

A vehicular sensing system includes a camera disposed at a vehicle equipped with the vehicular sensing system. The camera views a region exterior of the vehicle and at or near a door of the vehicle and is operable to capture image data. The camera includes an imager, and the imager includes a CMOS imaging array having at least one million photosensors arranged in rows and columns. An electronic control unit (ECU) includes electronic circuitry and associated software. The electronic circuitry of the ECU includes an image processor for processing image data captured by the camera and transferred to the ECU. The vehicular sensing system, responsive to detecting presence of a person exterior of the vehicle, and via processing at the ECU of image data captured by the camera and transferred to the ECU, determines an identity of the person (such as via facial recognition algorithms or techniques). The vehicular sensing system, responsive to the determined identity of the person corresponding to an authorized user of the vehicle, allows the person to access the vehicle.

For example, the system may store one or more profiles corresponding to authorized users and that optionally include functions of the vehicle that the user is authorized to use. Responsive to detecting an authorized user at the vehicle, the system grants access to the vehicle, such as by unlocking the vehicle doors, allowing the user to turn on a propulsion system of the vehicle, allowing the user to drive the vehicle and the like. The system may monitor a region exterior of the vehicle for potential users, such as by operating cameras in a low power mode (where the camera is operated at a low frame rate or low resolution), or by detecting the user grasping a door handle of the vehicle.

Responsive to detecting the potential user at or near the vehicle, the system processes the sensor data captured by the camera (at increased frame rate and/or increased resolution) to perform the facial recognition and determine authorization for the user.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2A is a schematic view of the vehicle as a potential user is outside a field of sensing of the vehicular sensing system;

FIG. 2B is a schematic view of the vehicle as the potential user is detected within the field of sensing of the vehicular sensing system and the system processes sensor data to perform facial recognition for granting the user access to the vehicle; and

FIG. 3 is a schematic view of the vehicle as the potential user is detected at the vehicle based on the user grasping a handle of the door.

### DESCRIPTION OF THE PREFERRED EMBODIMENTS

A vehicle vision system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide display, such as a rearview display or a top down or bird's eye or surround view display or the like.

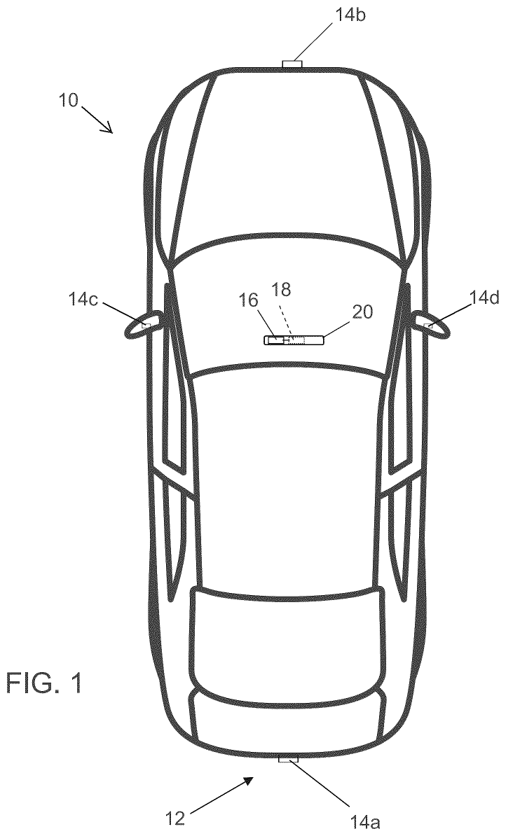

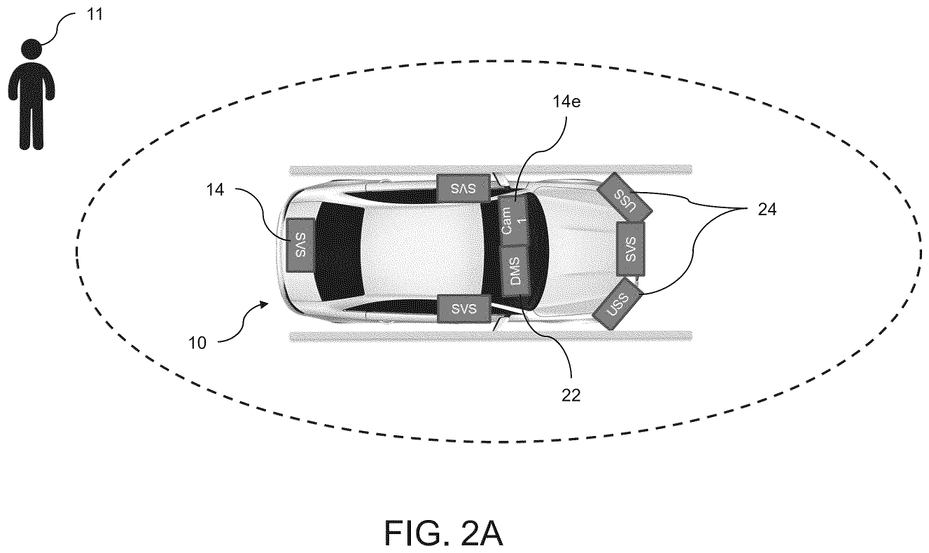

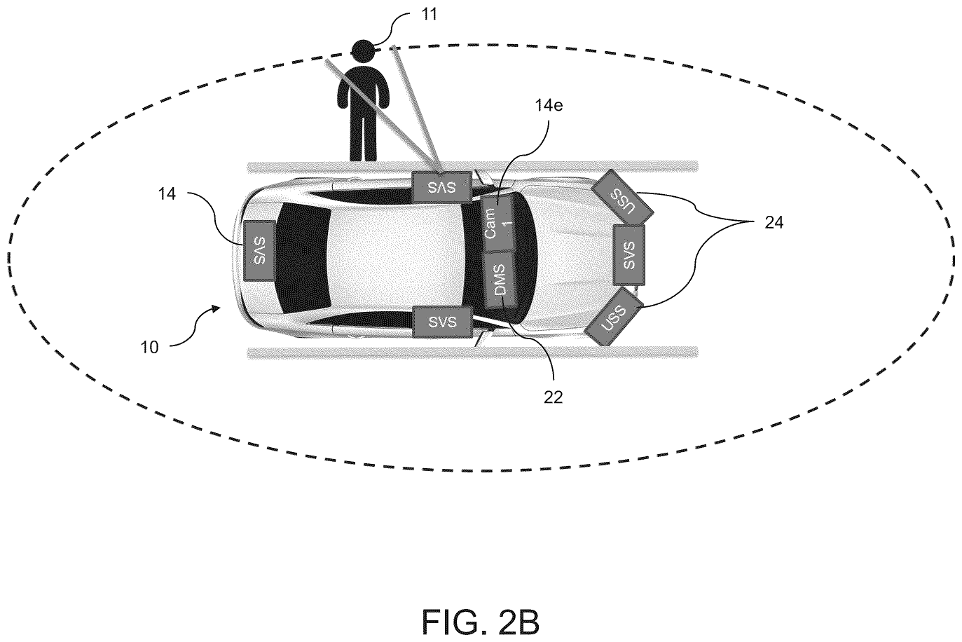

Referring now to the drawings and the illustrative embodiments depicted therein, a vehicle 10 includes a vehicular sensing system or imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera 14e may be disposed at the windshield of the vehicle and view through the windshield and forward of the vehicle, such as for a machine vision system (such as for traffic sign recognition, headlamp control, pedestrian detection, collision avoidance, lane marker detection and/or the like) (e.g., FIG. 2A). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Access to the vehicle is typically controlled via a key fob associated with the vehicle and that is carried by a driver of the vehicle, such as on a keyring. For example, the key fob may include inputs that are actuatable by the driver to lock and unlock the vehicle doors. The key fob may or may not include extra circuitry for security validation. Losing or damaging the key fob may result in the vehicle being inaccessible and/or inoperable unless the driver repairs or replaces the key fob.

As discussed further below, the vehicular sensing system 12 processes image data captured by one or more of the exterior viewing cameras at the vehicle 10 to perform facial recognition on persons attempting to access the vehicle 10 and validate identities associated with authorized drivers of the vehicle 10. Upon validation, the entire vehicle may become operable, meaning that doors may be unlocked, the propulsion system may be turned on, the vehicle can be driven, and the like. The extent of vehicle functionality that is enabled via facial recognition may be configurable by the vehicle owner.

Referring to FIG. 2A, when the vehicle 10 is parked and unoccupied, one or more sensors of the vehicle 10 may monitor regions at or near the vehicle to detect potential users or persons 11 approaching the vehicle 10. For example, the exterior viewing cameras 14 of the vehicle 10 comprise part of a surround view system (SVS) that captures image data representative of regions exterior of the vehicle 10, such as forward of the vehicle, along both sides of the vehicle and rearward of the vehicle. The vehicle 10 further includes a driver monitoring system (DMS) and/or occupant monitoring system (OMS) having a camera 22 that views at least a portion of the interior cabin of the vehicle. The DMS/OMS camera 22 captures image data that is processed for monitoring the driver and/or occupants within the cabin of the vehicle, such as for monitoring hand positions of the driver and occupants (e.g., at interior door handles), for eye tracking or gaze detection or driver attentiveness and the like.

Moreover, the vehicle 10 may include a plurality of ultrasonic sensors 24 disposed at the vehicle 10 and configured to sense respective regions exterior of the vehicle 10. In the illustrated example, the vehicle 10 includes ultrasonic sensors 24 at the forward portion of the vehicle, such as at the front bumper or grille or front fascia of the vehicle, and configured to sense at least forward and sideward of the vehicle 10. Optionally, the vehicle 10 may include ultrasonic sensors 24 disposed at side portions of the vehicle 10, such as at or near the wheel wells or wheel arches of the vehicle 10, which may be configured to sense regions exterior of the vehicle and at least along the respective sides of the vehicle. Ultrasonic sensors 24 may further be disposed at a rear portion of the vehicle 10, such as at or near a rear bumper of the vehicle 10, and may be configured to sense a region exterior of the vehicle and at least rearward of the vehicle.

Sensor data captured by exterior viewing sensors (e.g., the SVS cameras 14, the ultrasonic sensors 24, radar sensors at the vehicle and the like) may be processed to detect presence of persons 11 at or near or approaching the vehicle 10. For example, when the vehicle 10 is parked and unoccupied, the vehicular sensing system 12 may operate in a low power motion detection mode or monitoring mode or standby mode until a person 11 is detected approaching the vehicle 10. The cameras 14 may capture image data at a decreased resolution and/or lower frame rate to conserve power and/or other sensors at the vehicle (e.g., the ultrasonic sensors or radar sensors) may episodically or continuously capture sensor data until a person 11 is detected within a threshold distance of the vehicle 10.

In some examples, when operating in the low power mode, the system 12 may only operate cameras 14 that have a field of view at or near the sides of the vehicle and/or only process sensor data captured by cameras 14 that have a field of view at or near the sides of the vehicle 10 (i.e., one or both of the driver side of the vehicle and the passenger side of the vehicle). Thus, in the low power mode the system 12 may not operate and/or process sensor data from cameras 14 that do not view at or near the sides of the vehicle 10 (e.g., a rearward viewing camera and/or a forward viewing camera).

Optionally, the system 12 may process sensor data captured by sensors other than the cameras to monitor for the user 11 approaching the vehicle 10. For example, the system 12 may process sensor data captured by the ultrasonic sensors 24 and/or one or more radar sensors at the vehicle to detect users 11 within the threshold distance of the vehicle 10. To conserve power, the system 12 may episodically or periodically operate the vehicle sensors. That is, the system 12 may operate the sensors and/or process sensor data captured by the sensors in regular intervals separated by periods where the sensors are not operated and/or the system 12 does not process sensor data captured by the sensors.

The threshold distance may be based on a range of the field of view of the cameras, such that when at least one of the cameras 14 is able to detect the person 11 in the field of view of the camera 14, the person is less than the threshold distance from the vehicle. Put another way, the system 12 may determine that a person 11 is less than the threshold distance from the vehicle (and thus begin performing facial recognition), based on detecting the person 11 at a distance where the cameras 14 can reliably detect and/or perform facial recognition for the detected person 11. For example, the system 12 may monitor for the person 11 via ultrasonic sensor data or radar sensor data until the person 11 is within range of the cameras 14. Optionally, the threshold distance may be closer to the vehicle 10 than the range of the field of view of the cameras, such as a threshold distance of 10 meters or less, 5 meters or less, 1 meter or less, 0.5 meters or less and the like. Thus, the system 12 may not be triggered by each potential user that walks past the vehicle 10 (e.g., when the vehicle 10 is parked in a parking lot or near a busy sidewalk) and is only triggered when the person 11 is detected within the threshold distance. As shown in FIG. 2A, the person 11 is outside the threshold distance or sensing range of the sensing system 12 and thus the system is operating in the low power mode or monitoring mode.

Referring to FIG. 2B, responsive to detecting the person 11 at a distance from the vehicle 10 less than the threshold distance (e.g., within the field of view of one or more cameras 14), the vehicular sensing system 12 may operate in a detection mode to perform facial recognition on the approaching person 11. That is, the sensing system 12 processes image data captured by at least one camera 14 of the vehicle to determine an identity associated with the person 11 via facial recognition algorithms. The camera 14 may operate to capture image data at the cameras 14 full or normal frame rate and/or resolution. To perform facial recognition, the system 12 may process image data captured by each camera 14 of the vehicle 10, or the system 12 may only process image data captured by one or more cameras 14 at the side of the vehicle 10 at which the person 11 is detected, or the system 12 may only process image data captured by one or more cameras 14 determined to be viewing the person 11.

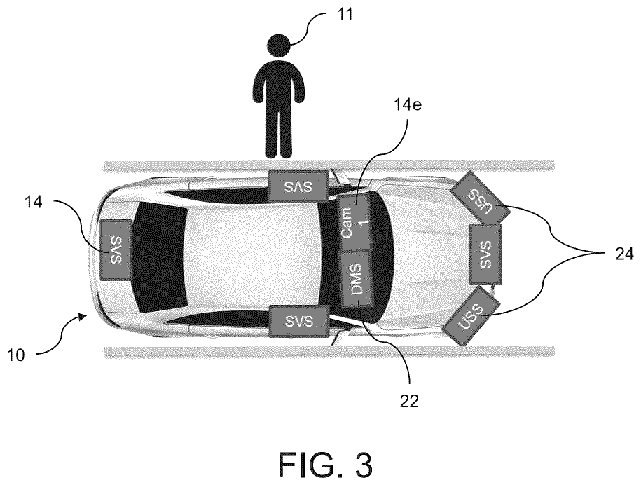

Referring to FIG. 3, responsive to detecting a hand at a door handle of the vehicle 10 and/or responsive to receiving an input from a user actuatable input (e.g., a button at the door or side of the vehicle), the sensing system 12 may operate in the detection mode to perform facial recognition on the person 11. In other words, the person 11 may approach the vehicle 10 and attempt to unlock the vehicle, such as by activating a sensor on the door handle or pressing a button at the door or side of the vehicle 10. Thus, presence of the person 11 at the side of the vehicle 10 may be detected without operating sensors to monitor the region surrounding the vehicle 10. The camera 14 may then operate to capture image data for performing facial recognition algorithms.

Thus, when a person of interest is detected (e.g., by processing sensor data to monitor the region exterior the vehicle and/or by detecting an input at the door handle of the vehicle), image data captured by one or more cameras 14 at the vehicle 10 is processed in an attempt to capture the face of the person 11 and perform facial recognition algorithms to determine if the person is authorized to access the vehicle 10. When the person 11 in the field of view of the camera 14 is confirmed to be a person authorized to access the vehicle 10, the vehicle 10 may be unlocked.

Further, the authorized user 11 may be able to activate a propulsion system of the vehicle 10 and drive the vehicle 10. After the authorized user has access to the vehicle 10, data captured by a DMS camera of the vehicle 10 may be processed to perform facial recognition and confirm the identity of the driver of the vehicle before activating the propulsion system.

When performing facial recognition, the vehicular sensing system 12 may process image data from one or more cameras 14 of the SVS, such as a sideward viewing camera at the side of the vehicle at which the potential user 11 is detected. Optionally, the vehicular sensing system 12 may process image data from a rearward viewing camera when the person 11 is detected at or near a trunk or liftgate or tailgate of the vehicle. Further, the vehicular sensing system 12 may process image data from a forward viewing camera when the person 11 is detected at or near a hood or front cargo cover panel of the vehicle 10. In some examples, the sensing system 12 may process image data from a camera having a field of view configured to view a head region of a person at or near the door of the vehicle. The camera may be disposed at the door, at the exterior rearview mirror assembly, at a pillar of the vehicle (e.g., an A-pillar, a B-pillar, a C-pillar, a D-pillar and the like), at the windshield, at a shark fin and the like.

The sensing system 12 may store one or more profiles associated with authorized users, such as in memory at the vehicle 10 or at a remote server in wireless communication with the vehicle 10. Thus, when performing facial recognition, the system 12 may attempt to match the person 11 at the vehicle with an identity of one of the profiles authorized to access the vehicle 10. Further, the profiles may identify a level of access granted to each authorized user. For example, some users may be authorized to access the vehicle (e.g., unlock and lock the vehicle doors and enter the vehicle cabin) and not authorized to drive the vehicle (e.g., turn on the vehicle propulsion system and operate the vehicle), while other users may be authorized to access the vehicle and drive the vehicle once confirmed via facial recognition. An owner of the vehicle may control user access to the vehicle 10. The maximum number of authorized users may be variable based on available resources and configurable by the vehicle owner.

Optionally, facial recognition may be in addition to requiring the use of a key fob, such that detecting presence of the key fob may trigger processing of the image data for facial recognition. In other words, the system 12 may operate in the detection mode to perform facial recognition in response to detecting presence of an authorized key fob at or near the vehicle and/or in response to receiving a signal from the authorized key fob. Thus, facial recognition performed by the vehicle sensing system 12 may operate as a form of secondary authentication and an unauthorized user in possession of the key fob may not operate the vehicle. This may provide security against vehicle theft in the event that an unauthorized user gains access to the key fob.

In some instances, a plurality of authorized users may be associated with one or more vehicles 10 equipped with the system 12 (e.g., a fleet of vehicles or a family vehicle), and an owner of the vehicle 10 may adjust which users may use the vehicle 10 and/or when the users may use the vehicle. For example, the system 12 may be configured so that a child or new driver is not authorized to access the vehicle 10 at night or an employee is not authorized to access the vehicle 10 when they are not scheduled to be working or a customer renting the vehicle 10 is not authorized to access the vehicle 10 outside their reservation window. Thus, users in possession of the key fob may still only gain access to the vehicle 10 if the system 12 performs facial recognition and determines that the user's identity corresponds to a currently authorized user of the vehicle 10.

Optionally, the system may identify other biometric features of potential users to grant access to the vehicle, such as voice recognition, fingerprint recognition and the like. The vehicular sensing system that uses facial recognition to grant vehicle access to authorized users may utilize characteristics of the biometric authorization systems described in U.S. Pat. No. 11,518,344, which is hereby incorporated herein by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward / rearward of the vehicle for a blind spot monitoring and alert system of the vehicle.

Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US- 2014-0336876, and/or U.S. patent application Ser. No. 19/290,465, filed Aug. 5, 2025 (Attorney Docket DON01 P5440), and/or International Publication No. WO 2023/220222 and/or International PCT Application No. PCT/US2025/038021, filed Jul. 17, 2025 (Attorney Docket DON01 FP5398WO) and/or International Patent Application Ser. No. PCT/US 25/27206, filed May 1, 2025 (Attorney Docket MAG04 FP5372WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
an exterior-viewing camera disposed at a vehicle equipped with the vehicular sensing system, wherein the exterior-viewing camera views a region exterior of the vehicle that is adjacent to a door of the vehicle, and wherein the exterior-viewing camera is operable to capture image data;
wherein the exterior-viewing camera comprises an imager, and wherein the imager comprises an imaging array having at least one million photosensors arranged in rows and columns;
an electronic control unit (ECU);
wherein image data captured by the exterior-viewing camera is transferred to the ECU;
wherein the ECU comprises electronic circuitry and associated software;
wherein the electronic circuitry of the ECU comprises an image processor for processing image data captured by the exterior-viewing camera and transferred to the ECU;
wherein the vehicular sensing system is operable, at least via processing image data captured by the exterior-viewing camera and transferred to the ECU, to detect presence of a person exterior of the vehicle;
wherein the vehicular sensing system, while presence of a person exterior of the vehicle is not detected, operates in a first state where image data captured by the exterior-viewing camera is processed at a first resolution, and wherein the vehicular sensing system, responsive to detecting the presence of a person exterior of the vehicle, operates in a second state where image data captured by the exterior-viewing camera is processed at a second resolution that is greater than the first resolution;
wherein the vehicular sensing system, responsive to detecting the presence of a person exterior of the vehicle, and at least in part via processing of captured image data at the second resolution, determines whether the detected person is an authorized user of the vehicle; and
wherein the vehicular sensing system, responsive to determining that the detected person is an authorized user of the vehicle, allows the detected person to access the vehicle.

2. The vehicular sensing system of claim 1, wherein the vehicular sensing system determines whether the detected person is the authorized user via facial recognition techniques.

3. The vehicular sensing system of claim 1, wherein the vehicular sensing system adjusts operation from the first state to the second state responsive to detecting the presence of a person exterior of the vehicle and within a threshold distance of the vehicle.

4. The vehicular sensing system of claim 1, wherein the vehicular sensing system controls a door locking mechanism of the vehicle to move from a locked state to an unlocked state to allow the detected person to access the vehicle.

5. The vehicular sensing system of claim 1, wherein the door comprises at least one selected from the group consisting of (i) a driver's door, (ii) a passenger's door, (iii) a liftgate, (iv) a trunk lid and (v) a front cargo area cover.

6. The vehicular sensing system of claim 1, wherein the exterior-viewing camera is disposed at one selected from the group consisting of (i) the door, (ii) an exterior rearview mirror assembly of the vehicle at a side of the vehicle corresponding to the door, (iii) a pillar of the vehicle, (iv) a windshield of the vehicle and (v) a shark fin antenna of the vehicle.

7. The vehicular sensing system of claim 1, wherein a plurality of cameras are disposed at the vehicle equipped with the vehicular sensing system, and wherein individual cameras of the plurality of cameras view respective regions exterior of the vehicle, and wherein the individual cameras of the plurality of cameras are operable to capture image data, and wherein the individual cameras of the plurality of cameras include the exterior-viewing camera that views the region exterior of the vehicle and adjacent to the door of the vehicle.

8. The vehicular sensing system of claim 7, wherein the vehicular sensing system detects presence of the person exterior of the vehicle via processing, at the first resolution, image data captured by the exterior-viewing camera and transferred to the ECU.

9. The vehicular sensing system of claim 7, wherein the vehicular sensing system detects presence of the person exterior of the vehicle via processing, at the first resolution, image data captured by the individual cameras of the plurality of cameras.

10. The vehicular sensing system of claim 7, wherein the vehicular sensing system, while presence of a person exterior of the vehicle is not detected, operates in the first state where image data captured by the plurality of cameras is processed at the first resolution, and wherein, responsive to detecting presence of the person exterior of the vehicle, (i) image data captured by the exterior-viewing camera viewing the region exterior of the vehicle that is adjacent to the door of the vehicle is processed at the second resolution and (ii) image data captured by other cameras of the plurality of cameras continues to be processed at the first resolution.

11. The vehicular sensing system of claim 7, wherein, responsive to detecting presence of the person exterior of the vehicle, image data captured by each camera of the plurality of cameras is processed at the second resolution.

12. A vehicular sensing system, the vehicular sensing system comprising:
a camera disposed at a vehicle equipped with the vehicular sensing system, wherein the camera views a region exterior of the vehicle that is adjacent to a door of the vehicle, and wherein the camera is operable to capture image data;
wherein the camera comprises an imager, and wherein the imager comprises an imaging array having at least one million photosensors arranged in rows and columns;
a non-imaging sensor disposed at the vehicle, wherein the non-imaging sensor senses exterior of the vehicle, and wherein the non-imaging sensor is operable to capture sensor data;
an electronic control unit (ECU);
wherein image data captured by the camera is transferred to the ECU;
wherein sensor data captured by the non-imaging sensor is transferred to the ECU;
wherein the ECU comprises electronic circuitry and associated software;
wherein the electronic circuitry of the ECU comprises at least one data processor for (i) processing image data captured by the camera and transferred to the ECU and (ii) processing sensor data captured by the non-imaging sensor and transferred to the ECU;
wherein the vehicular sensing system is operable, at least via processing sensor data captured by the non-imaging sensor and transferred to the ECU, to detect presence of a person exterior of the vehicle;
wherein the vehicular sensing system, while presence of a person exterior of the vehicle is not detected, does not operate the camera to capture image data, and wherein the vehicular sensing system, responsive to detecting the presence of a person exterior of the vehicle, operates the camera to capture image data;
wherein the vehicular sensing system, responsive to detecting the presence of a person exterior of the vehicle, and at least in part via processing at the ECU of image data captured by the camera and transferred to the ECU, determines whether the detected person is an authorized user of the vehicle;
wherein the vehicular sensing system determines whether the detected person is the authorized user via facial recognition techniques; and
wherein the vehicular sensing system, responsive to determining that the detected person is an authorized user of the vehicle, allows the detected person to access the vehicle.

13. The vehicular sensing system of claim 12, wherein the non-imaging sensor is part of a plurality of non-imaging sensors disposed at the vehicle and sensing respective regions exterior of the vehicle.

14. The vehicular sensing system of claim 12, wherein the non-imaging sensor comprises a radar sensor.

15. The vehicular sensing system of claim 12, wherein the non-imaging sensor comprises an ultrasonic sensor.

16. A vehicular sensing system, the vehicular sensing system comprising:
a camera disposed at a vehicle equipped with the vehicular sensing system, wherein the camera views a region exterior of the vehicle that is adjacent to a door of the vehicle, and wherein the camera is operable to capture image data;
wherein the camera comprises an imager, and wherein the imager comprises an imaging array having at least one million photosensors arranged in rows and columns;
an electronic control unit (ECU);
wherein image data captured by the camera is transferred to the ECU;
wherein the ECU comprises electronic circuitry and associated software;
wherein the electronic circuitry of the ECU comprises an image processor for processing image data captured by the camera and transferred to the ECU;
wherein the vehicular sensing system detects presence of a person exterior of the vehicle based on receiving a signal from a user actuatable input exterior of the vehicle;
wherein the vehicular sensing system, while presence of a person exterior of the vehicle is not detected, does not operate the camera to capture image data, and wherein the vehicular sensing system, responsive to detecting the presence of a person exterior of the vehicle, operates the camera to capture image data;
wherein the vehicular sensing system, responsive to detecting the presence of a person exterior of the vehicle, and at least in part via processing at the ECU of image data captured by the camera and transferred to the ECU, determines whether the detected person is an authorized user of the vehicle;
wherein the vehicular sensing system determines whether the detected person is the authorized user via facial recognition techniques; and
wherein the vehicular sensing system, responsive to determining that the detected person is an authorized user of the vehicle, allows the person to access the vehicle.

17. The vehicular sensing system of claim 16, wherein the user actuatable input is disposed at a handle at the door of the vehicle, and wherein the vehicular sensing system detects the presence of a person exterior of the vehicle via sensing the person grasping the handle at the door of the vehicle.

18. The vehicular sensing system of claim 16, wherein the user actuatable input is disposed at an exterior portion of the vehicle and spaced from a handle at the door of the vehicle.

19. The vehicular sensing system of claim 16, wherein the user actuatable input is disposed at a key fob associated with the vehicle.

20. The vehicular sensing system of claim 16, wherein the door comprises at least one selected from the group consisting of (i) a driver's door, (ii) a passenger's door, (iii) a liftgate, (iv) a trunk lid and (v) a front cargo area cover.
